(19) United States
(12) Patent Application Publication
(10) Pub. No.: US 2010/0108763 A1
(43) Pub. Date: May 6, 2010

(54) Device and Method for Optically Scanning Three-Dimensional Objects

(76) Inventor: Martinus Machiel Verhoeven, Hoenzadriel (NL)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/279,634

(22) PCT Filed: Feb. 14, 2007
(86) PCT No.: PCT/NL07/00042

§ 371 Date: Jan. 12, 2010

(30) Foreign Application Priority Data
Feb. 15, 2006 (NL) 1031153

(51) Int. Cl. G06K 7/10

(52) U.S. Cl. 235/454

(57) ABSTRACT

A device for optically scanning three-dimensional objects provided with at least one optically readable code, using at least one optical reader. The device comprises a rotatably disposed container arranged for receiving an object to be scanned therein. The container is provided with at least one optically transparent window in a wall thereof. The optical reader is spaced from the container by some distance, such that the optically readable code of an object present in the container is positioned in front of the at least one window and the at least one window is positioned in front of the reader by rotating the container so as to enable scanning of the optically readable code.

The invention relates to a device and method for optically scanning three-dimensional objects for reading an optically readable code, such as a well known bar code, on an object or on the packaging of an object by means of at least one optical reader, such as an optical scanner or a camera and the like.

Such an optically readable code is used to allot a code to an object so as to enable machine-identification thereof. The optically readable code is generally randomly provided on a surface or on several surfaces of an object or packaging of an object, depending on manufacturers' requirements and preferences. There is no prescribed position at which the code is to be provided. In practice this makes it more difficult for such optical codes to be read fully automatically, because it is not known in advance where the code in question is present on an object or packaging of an object.

A solution to this problem is for example to use a plurality of optical readers, which are capable of scanning a respective object from several directions, thus increasing the chance that the optical code can be read automatically, i.e. without human interaction. A problem in this connection is the focussing of the optical readers, in particular when scanning objects of varying dimensions and in the case of optical readers that scan the optically readable code at an oblique angle. Generally this requires the use of comparatively high-quality optical readers, which undesirably increases the overall costs of a device.

As a solution to the focussing problem and in order to limit the number of readers, fairly complex optical systems provided with mirrors, prisms and other optical components have been constructed in practice. The costs of such optical constructions are likewise comparatively high, also because measures need to be taken to maintain the optical components and the reader(s) in a stable position relative to each other. These optical systems are furthermore vulnerable and less suitable for use in rough operating conditions.

Furthermore a system is known in practice wherein an object to be scanned is moved past an optical reader with a different side surface thereof each time, using a manipulator provided with a gripper. A drawback of this system is inter alia the fact that when the fingers of the gripper by which the object is gripped are positioned in front of the optical code to be scanned, identification cannot take place and the code on the object must be “reallotted”, i.e. the optical code must be provided at a different position on the object so as to be able to read the code yet in a second attempt.

Accordingly, it is an object of the invention to provide a device for optically scanning three-dimensional objects in a reliable manner without having to use optical aids in the form of mirrors, prisms and the like and without having to use comparatively high-quality readers.

In order to achieve this object, the invention provides a device for optically scanning three-dimensional objects provided with at least one optically readable code, using at least one optical reader, characterised by a rotatably disposed container arranged for receiving an object to be scanned therein, which container is provided with at least one optically transparent window in a wall thereof, wherein the optical reader is spaced from the container by some distance, such that the optically readable code of an object present in the container is positioned in front of the at least one window and the at least one window is positioned in front of the reader by rotating the container so as to enable scanning of the optically readable code.

In the device according to the invention, by suitably rotating the container with an object present therein, the object with one or more sides thereof is placed in front of said the least one optically transparent window of the container, among which the side or sides on which the optically readable code is present, which can subsequently be scanned by the reader when the window is rotated in front of the reader or into the reader's field of view.

Because a side on which an optical code to be scanned is provided will eventually be positioned in front of the at least one optically transparent window of the container and in the field of view of the optical reader as a result of the object being rotated, it will essentially suffice to use a single reader in the device according to the invention, without complex and vulnerable mirror constructions, lens constructions or other optical constructions being required.

The shape of the container according to the invention may be selected at random or, on the contrary, be adapted to the shape of a product or object to be scanned. In the most general embodiment, the container is a space enclosed by a three-dimensional polyhedron, which is provided with an opening for receiving an object to be scanned in said space. Suitable polyhedrons are for example so-called platonic bodies, such as a tetrahedron, a hexahedron, an octahedron or the like, or so-called Archimedean bodies, among which a truncated tetrahedron, a truncated hexahedron, a cuboctahedron and the like.

In addition to that, in an embodiment of the invention the container may also have the shape of a body of revolution, such as a cone, a circular cylinder, a quadrangular cylinder or beam or the like, provided with an opening for receiving the object to be scanned therein.

In a preferred embodiment of the invention, the at least one reader and the container are positioned in such a manner relative to each other that the at least one optically transparent window will move past the reader at a fixed distance therefrom upon rotation of the container.

By ensuring that the product or object to be scanned is positioned at a fixed distance from the window with the side provided with the optically readable code when the window is in the reader's field of view during the aforesaid rotation, for example in that the side of the product or object in question is positioned against or on the window or the wall of the container in which the window is present, the focussing problem that is known from the prior art does not occur when using the device according to the invention. The optically readable code is then spaced a fixed, predefined distance from the reader at all times when the code or the window is in the reader's field of view. The reader may advantageously be positioned directly opposite the window in that case. It will be understood that in this preferred embodiment of the invention the reader may be of a comparatively simple type, without any complex and costly solutions for focussing and correcting parallax, which has an advantageous effect as regards reducing the costs of the device according to the invention in comparison with the above-described solutions according to the prior art.

A suitable container is a body of revolution which is disposed for rotation about its axis of rotation, wherein the at least one optically transparent window is provided in a boundary wall of the container that extends in the longitudinal direction of the axis of rotation.

A container having a circular cylindrical section is very suitable for example for scanning an optically readable code that is present on the circumference of a circular cylindrical product or object. If there is sufficient friction between the inner circumference of the container and the outer circumference of the product or object to be scanned, and the dimensions of the inner circumference of the container are larger than those of the outer circumference of the object in question, rotation of the container about its axis of rotation will result in rotation of the object in question as well, so that the code will eventually “roll” in front of the window, where it can be scanned by the reader.

A container in the shape of a cylindrical body of revolution having a quadrangular section or a cubic or beam-like shape, with an optically transparent window present in each boundary wall that extends in the longitudinal direction of the axis of rotation, is very suitable for example for scanning an optically readable code that is present on a side of a square, rectangular or generally hexahedral object or packaging of an object. By ensuring that the inner circumference of the container is sufficiently smooth and has dimensions larger than those of the object, which may or may not be packaged, each side of the object will “slide” along a corresponding boundary wall, past the window formed therein, under the influence of gravity upon rotation of the container to enable scanning by the reader when the window in question rotates in front of the reader.

In an embodiment of the invention, the boundary walls in question are preferably optically transparent in their entirety. In a preferred embodiment of the invention, the container is preferably optically transparent on all sides, for example configured as a container made of a transparent plastic or glass.

In an advantageous embodiment, a container configured as a body of revolution, which is disposed for rotation about its axis of rotation, is open on one short side or on each short side for receiving an object to be scanned in the container.

In a preferred embodiment of the invention, in which the container is configured as a body of revolution disposed for rotation about its axis of rotation, the body of revolution has a square section, wherein the reader is disposed at the bottom side of the container, such that the reader's field of view lies opposite a boundary wall of the container extending in the longitudinal direction of the axis of rotation in the position in which the boundary wall in question includes an angle of substantially 45° with a line that extends vertically with respect to the container.

In this embodiment of the invention, advantageous use is made of the fact that the object to be scanned takes up a stable position under the influence of gravity when it abuts against the lower boundary walls of the container. This effect occurs when the object to be scanned comes to lie on the line of intersection of the boundary walls, which happens in practice when a respective boundary wall includes an angle of about 30° or more with an imaginary vertical line. In this stable position reliable scanning of the object is possible, in which case the reader's field of view must lie directly opposite a respective side of the square or rectangular object, so that parallax or other reading errors resulting from the fact that the object in question is being scanned at an oblique angle are prevented. In an advantageous embodiment, the reader is positioned so that its field of view extends from a lower edge of the respective boundary wall of the container. By disposing the reader in this way it can be ensured that a respective side of the object to be scanned will lie within the reader's field of view in its entirety.

The device according to the invention also comprises moving means for moving an object to be scanned into an out of a container, rotating means for rotating the container and electronic control means, wherein the moving means, the rotating means, the control means and the at least one reader are interconnected in such a manner that the rotating means are driven to rotate the container after an object to be scanned has been placed into the container, and that the rotating means are controlled to stop rotating after an optical code of the object in question has been scanned and the moving means are driven to move the object out of the container.

In those cases in which it is not possible to scan an optical code, not even after the object to be scanned has been rotated such that all sides thereof have been in the reader's field of view, the device further comprises time monitoring means for interrupting the scanning process after a preset period of time and removing the object from the container to start a new scanning cycle with a new object.

In an embodiment of the device according to the invention the moving means comprise at least one runner mounted to the container as well as drive rollers engaging the at least one runner for rotating the container. In particular in the case of a container in the form of a body of revolution a runner is provided on both short sides of the container, wherein the bearing rollers engage both runners for rotating the container about its axis of rotation.

In the case of a container in the form of a body of revolution of which at least one short side is open, the device according to the invention provides moving means arranged for moving an object to be scanned into and out of the container via the at least one open short side thereof. Preferably the container is closed at the other short side, and the moving means are arranged for placing the object to be scanned into the container in such a manner that the object will abut against the closed short side. In this way an unequivocal starting position of the object to be scanned is obtained.

In yet another embodiment of the device according to the invention, a reader is disposed on each short side of the container so as to be able to scan also objects with the optical code present on a short side thereof.

In a preferred embodiment, means are provided for moving the container along a path such that each short side thereof is moved past a respective reader, wherein the readers may be disposed in staggered relationship on the short side. In conjunction with a reader disposed opposite a boundary wall extending in the direction of the axis of rotation, it is thus possible to realise a complete scanning of an object to be scanned, in particular a rectangular or cubic object, using three comparatively simple and comparatively inexpensive readers.

The invention also relates to a method for optically scanning three-dimensional objects provided with at least one optically readable code by means of at least one optical reader, characterised by the steps of:

placing an object to be scanned in a rotatably disposed container, which container is provided with at least one optically transparent window in a wall thereof,

rotating the container such that the optically readable code of an object present therein can be positioned in front of the at least one window and that the at least one window is positioned in front of the or each reader, and

reading the or each optically readable code with the or each reader.

In those cases in which it is not possible to read the code, the method according to the invention provides the steps of stopping the rotation of the container and removing the object from the container after a predetermined period of time has lapsed after the rotation of the container was started.

The invention will now be explained in more detail in the following description of preferred embodiments for scanning rectangular or cubic, generally hexahedral objects or packagings of objects, in which reference is made to the appended drawings. The invention is by no means limited to these preferred embodiments, which are also described herein because it is felt that these embodiments provide the best understanding of the invention.

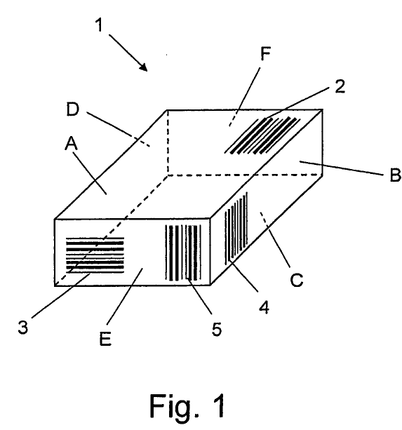

FIG. 1 schematically shows an object or packaging of an object of generally hexahedral shape, which is provided with one or more optically readable codes, such as bar codes.

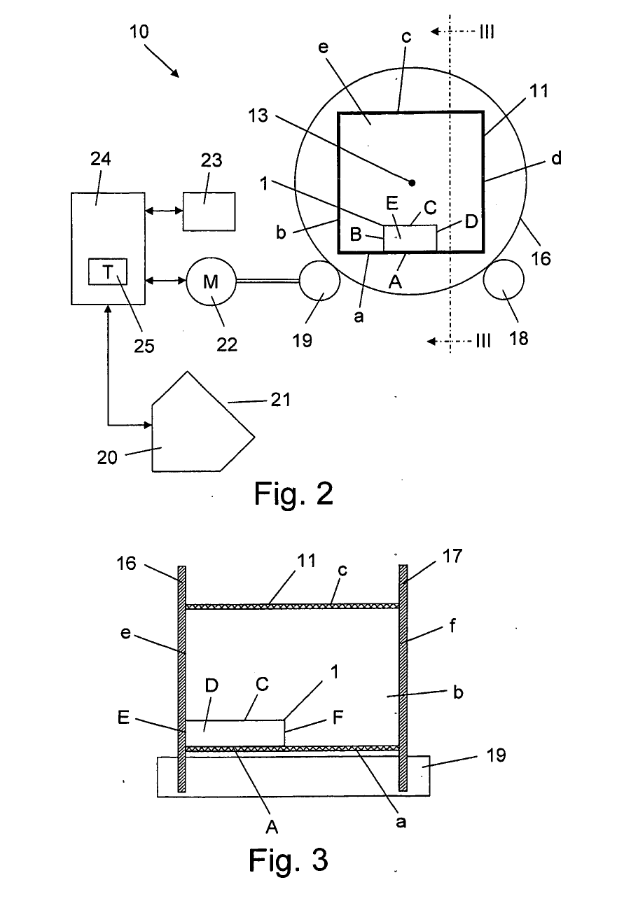

FIG. 2 schematically shows an embodiment of a device according to the invention comprising a container in the form of one elongated body of revolution, seen from a short side thereof.

FIG. 3 is a schematic sectional view along the line of the device according to FIG. 2.

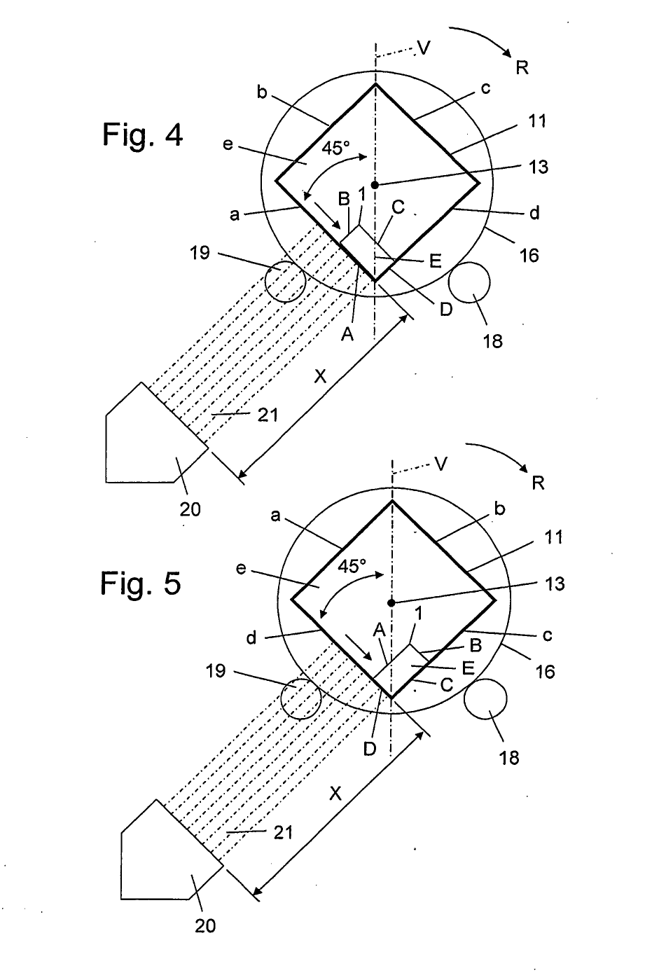

FIGS. 4-7 show the device of FIG. 2 in several rotational positions in the plane of the drawing, with an object to be scanned present in the container.

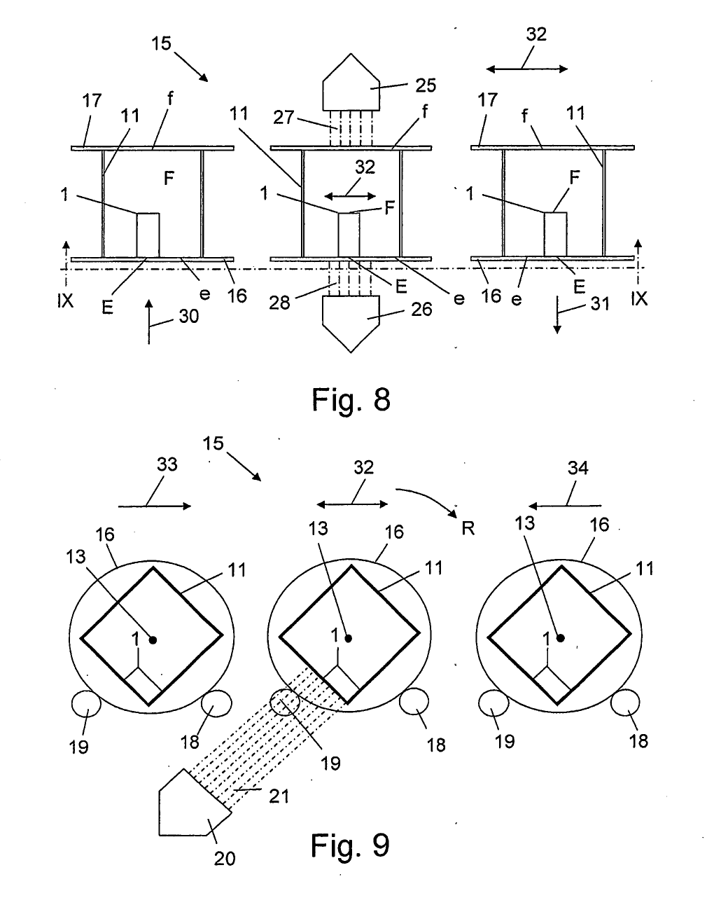

FIG. 8 is a schematic plan view of a further embodiment of the device according to the invention, in which the container is moved from the left to the right in the plane of the drawing.

FIG. 9 is a schematic front view along the line IX-IX of the device according to FIG. 8.

The object or product or packaging of an object of product indicated at 1 in FIG. 1, which designations are to be considered to be synonymous within the framework of the present description and the claims, is hexahedral in shape, comprising six flat sides A, B, C, D, E, F. The sides A and C are positioned opposite each other and form the upper side and the bottom side, respectively, of the object 1, seen in the orientation of the drawing. The sides B and D are opposing long sides of the object 1 and the opposing sides E and F are the short sides or end sides of the object 1.

The sides A, B, E and F are provided with optically readable codes indicated at 2, 3, 4 and 5, respectively. These codes may be bar codes which are known per se, for example, by which an object can be identified. It will be understood that the codes 2, 3, 4, 5 may also be other optically readable codes and that the codes in question may also be provided on other sides of the object 1 than the sides which are shown by way of example in FIG. 1.

FIG. 2 shows a preferred embodiment of the device according to the invention, which is indicated as a whole at 10. The device 10 comprises a horizontally disposed container 11, which is optically transparent on all sides, in the form of a body of revolution that encloses a space of square section. The container extends in the plane of the drawing with its axis of rotation 13. The boundary walls of the container 11 extending in the longitudinal direction of the axis of rotation 13 are indicated at a, b, c and d, respectively. In FIG. 2 the container is shown from a short side e thereof, which side is open so as to make it possible to place an object 1 in the container 11.

FIG. 3 shows the device of FIG. 2 along the line therein, i.e. in the longitudinal direction of the container 11. The short side f of the container 11 is closed in this embodiment.

To rotate the container 11 about the axis of rotation 13, runners 16 and 17 are fixedly connected to the container 11 on each short side e, f, respectively, of the container 11. Bearing rollers or drive rollers 18, 19 frictionally engage said runners 16, 17 for supporting and driving the runners 16, 17 for the purpose of rotating the container 11 about the axis of rotation 13. In the illustrated embodiment, the runner 16 is open to enable placement of an object in the container 11 from the short side e.

Those skilled in the art will appreciate that the bearing rollers 18, 19 may also engage the runners 16, 17 at the upper side in the plane of the drawing, and that various other drive means may be used for rotating the container 11, for example belt drive or gear drive means. All drive means of this kind are considered to be included in the term “rotating means”.

An optical reader 20, whose optical field of vision or field of view, is indicated at 21, is disposed at the bottom side (in the plane of the drawing) of the container 11. The optical reader 20 may be any device for scanning optically readable codes that is suitable for the purpose of the invention, for example an optical scanner that is commercially available for this purpose, a video camera or other (future) optical scanning means.

Furthermore, electronic control means 24 are provided, which control means are connected to the reader 20, to a motor 22 for driving one or both bearing rollers 18, 19, and to moving means 23, which are schematically indicated as a block. The moving means 23 are arranged for moving an object 1 into and out of the container 11. The moving means 23 may have any suitable configuration, including for example a push arm for placing the object 1 into the container 11 and a pull arm, combined with the push arm, if necessary, for moving the object 1 out of the container 11 once it has been optically scanned. To this end the control means 24 are preferably also provided with time monitoring means 25.

When the container 11 is stationary, an object 1 is placed in the container 11 by the moving means 23 under the control of the control means 24. Preferably with the side F of the object 1 against the short side f of the container 11 (not shown). In this way an unequivocal scanning position with respect to the reader 20 is effected at all times.

Then the motor 22 is energised, under the influence of which the bearing rollers 18, 19 will start rotating. As a result of the frictional engagement between the bearing rollers 18, 19 and the runners 16, 17, the container 11 will start rotating about its axis of rotation 13, for example in clockwise direction in the plane of the drawing, as a result of which the four sides A, D, C, B are successively brought into the field of view 21 of the reader 20 for scanning or reading an optical code 2-5.

After one or all of the optical codes 2, 3, 4, 5 on the object 1 has (have) been scanned, the scanning cycle, i.e. the rotation of the container may be terminated. To that end the reader 20 delivers a signal to the control means 24, which subsequently interrupt the energization of the motor 22. When the container is stationary, the object 1 can be removed from the container 11, using the moving means 23.

Subsequently a new object may be placed in the container 11 for identification thereof, and so on.

In those cases in which no optical code is detected, even after sufficient revolutions of the container 11, time monitoring means 25 interfere after the expiry of a period of time T, which is to be set in the control means 24, and stop the drive of the bearing rollers 18, 19, after which the non-identified object is removed from the container 11. Each time a new object to be scanned is placed in the container 11, the time monitoring means 25 are reset or started from a starting position.

FIGS. 4-7 successively show how the sides A, D, C, B of the object 1 are placed in the field of view 21 of the reader 20, with the container 11 rotating in the direction indicated by the arrow R. It is assumed in this connection that the boundary walls a, b, c, d are so smooth on the inner side of the container that the objects 1 can slide along these walls under the influence of gravity. It stands to reason that the container 11 will have internal dimensions well in excess of those of an object of 1, in a case such that the object 1 can slide along the boundary walls a, b, c, d inside the container 11.

Seen from the starting position in FIG. 1, the side A of the object 1 is the first side to come within the field of view 21 of the reader 20, see FIG. 4. Since the boundary walls a, b, c, d of the container 11 are optically transparent, for example made of glass or plexiglass or the like, the reader 20 can scan the sides A of the object 1 for (an) optical code(s). The reader 20 is disposed in such a manner that its field of view 21 lies directly opposite a boundary wall a, b, c, d of the container when the boundary wall in question includes an angle of 45° with an imaginary vertical line V through the axis of rotation 13 of the container 1 in the plane of the drawing. The object 1 stably abuts against the lower boundary walls a and d, respectively, of the container 11 with its sides A and D during that time under the influence of gravity.

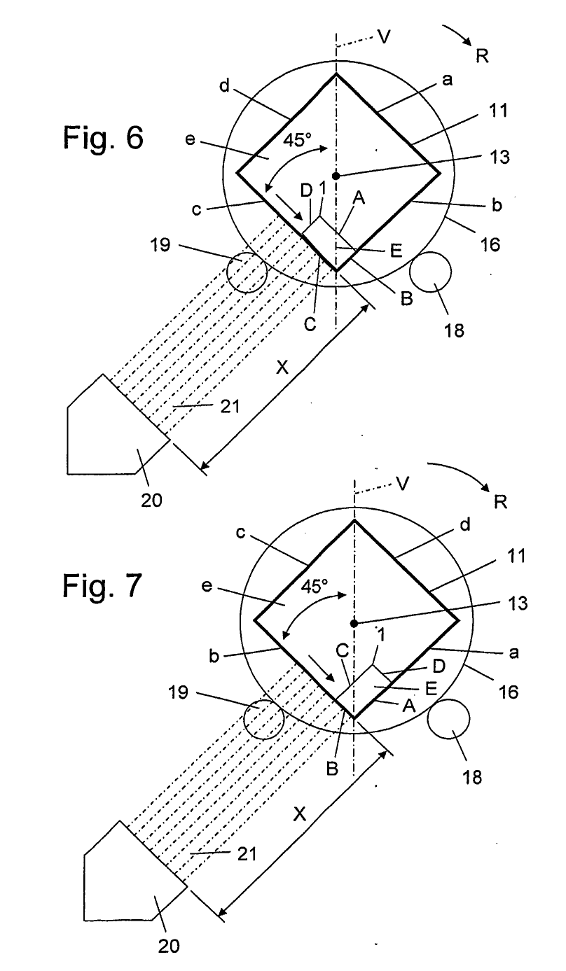

Upon further rotation of the container 11 in the direction indicated by the arrow R, the object 1 will slide down along the boundary wall d in the container 11 with its side D to the stable position shown in FIG. 5, in which the side D is positioned directly opposite the reader 20. Subsequently the sides C and B are scanned, as illustrated in FIGS. 6 and 7. The short arrows in the container 11 represent the movement of the object 1 along the inner side of a respective boundary wall a, b, c, d of the container 11.

It will be understood that in this example the rotational speed of the container 11 will be such that the object will slide down along a boundary wall a, b, c, d upon rotation of the container 11. In other embodiments, on the other hand, it may for example be necessary to rotate a respective container in such a manner as to cause a respective object to tilt in the container or the like.

Note that one side of the object is positioned directly opposite the field of view 21 of the reader 20 for scanning at all tithes, so that there will be no parallax or offset problems caused by the fact that scanning, for example of a bar code, takes place at an oblique angle and that the distance X from a side A, B, C, D to be scanned to the reader 20 will be constant at all times, irrespective of the dimensions of the object 1, as a result of which no focussing problems will occur with the device according to the invention, therefore. This makes it possible to use a reader 20 of a relatively simple type.

The reader 20 is so disposed with respect to the container that it will scan the area of a boundary wall a, b, c, d, starting from the lowermost point, seen when the boundary walls of the container include an absolute angle of 45° with the imaginary vertical line V. It will be understood that when the scanning process is disturbed, for example by the bearing roller 19, the bearing roller may also engage the runners 16, 17 at the upper side.

Scanning of the short sides E and F of the object 1 is carried out in the embodiment of the invention as shown in FIG. 8, which is indicated as a whole at 15. FIG. 8 is a plan view of the device 15. In this embodiment two additional readers 25, 26 are positioned directly opposite a short side e, f, respectively, of the container 11. Also in this case there will be no parallax or offset problems during scanning. The container 11 is moved from the left to the right in the plane of the drawing, to which end additional means (not shown) are provided for moving the container 11 along this path. The short sides e, f of the container, and thus the short sides E, F of the object 1, are moved past a reader 25, 26, respectively, for reading a respective optical code one or both sides E, F of the object 1.

The arrows 30 and 31 schematically indicate the placement of an object to be scanned into the container 11 and the removal therefrom. The arrow 32 indicates the direction of movement of the container 11 along the path from the left to the right and/or vice versa.

While the container 11 travels along the aforesaid path, it may also be rotated about its axis of rotation 13, for example as indicated by the arrow R for scanning by the reader 20, as explained in the foregoing and illustrated in FIG. 9, which is a front view of the device 15, seen from the line IX-IX in FIG. 8. The arrows 32, 33 and 34 in FIG. 9 indicate the direction of movement of the container 11.

Thus a hexahedral object 1 can be completely scanned in a reliable manner on all sides by means of the device according to FIG. 8 and FIG. 9 while using comparatively simple optical readers.

It will be understood that the reader 20 may also be disposed at other positions with respect to the container, and that the container may for example also be of circular cylindrical section, for example for reading an optical code on a circular cylindrical object which is set rotating in the container by the rotation of the container, in which case the reader may be disposed directly above or below the container, for example.

The container 11 does not necessarily have to be transparent on all sides. It may for example suffice to provide suitable optically transparent windows in the boundary walls a, b, c, d and/or the short sides e, f of the container 11.

It will be appreciated that the container may have any other suitable shape than that of a body of revolution, with other specific rotational movements, etc. All these embodiments and modifications thereto are considered to be included in the appended claims.

1. A device for optically scanning a three-dimensional object provided with at least one optically readable code, said device comprising at least one optical reader, a container arranged for receiving therein said object to be scanned, said container having at least one optically transparent window in a boundary wall thereof, wherein said at least one optical reader is spaced from said container by a distance, and wherein said container is rotatably supported such that an optically readable code of an object received in said container is positioned in front of said at least one window and said at least one window is positioned in front of said at least one optical reader by rotating said container.

2. A device according to claim 1, wherein said container is a space entirely enclosed by a three-dimensional polyhedron, which is provided with an opening for receiving an object to be scanned in said enclosed space.

3. A device according to claim 1, wherein said container is a platonic body.

4. A device according to claim 1, wherein said container is an Archimedian body.

5. A device according to claim 1, wherein said container is a body of revolution.

6. A device according to claim 1, wherein said container is a body of revolution, which is disposed for rotation about its axis of rotation.

7. A device according to claim 1, wherein said container has a circular cylindrical section.

8. A device according to claim 1, wherein said container has a quadrangular section.

9. A device according to claim 1, wherein said at least one optically transparent window is provided in a boundary wall of said container extending in longitudinal direction of its axis of rotation.

10. A device according to claim 1, wherein an optically transparent window is present in each boundary wall of said container extending in longitudinal direction of its axis of rotation.

11. A device according to claim 10, wherein at least one boundary wall of said container is formed as an optically transparent window.

12. A device according to claim 1, wherein said container is an elongated body of revolution, which is disposed for rotation about its axis of rotation, said container having at least one open short side for receiving an object to be scanned therein.

13. A device according to claim 1, wherein said container is optically transparent in its entirety.

14. A device according to claim 1, wherein said at least one reader and said container are arranged such that said at least one optically transparent window will move past said at least one reader at a fixed distance therefrom, upon rotation of said container.

15. A device according to claim 1, wherein said container has a square section and is supported for rotation in a horizontal plane, wherein said at least one reader is disposed having its field of view opposite a boundary wall of said container extending in longitudinal direction of its axis of rotation, in a position in which said boundary wall includes an angle of essentially 45 degrees with a line extending vertically with respect to said container.

16. A device according to claim 1, wherein said container has a square section and is supported for rotation in a horizontal plane, wherein said reader is positioned such that its field of view extends from a lower edge of a respective boundary wall of said container.

17. A device according to claim 1, comprising moving means for moving an object to be scanned into an out of said container, rotation means for rotating said container and electronic control means, wherein said moving means, said rotation means, said control means and said at least one reader are operatively engaged such that said rotation means are controlled to rotate said container after an object to be scanned has been placed in said container, and said rotation means are controlled to stop rotating after an optical code of said object has been scanned and said moving means are controlled to move said object out of the said container.

18. A device according to claim 1, comprising moving means for moving an object to be scanned into and out of said container, rotation means for rotating said container and electronic control means, further comprising time monitoring means connected to said control means for controlling said rotation means to stop rotation of said container after a preset period of time and for controlling said moving means to remove said the object to be scanned from said container.

19. A device according to claim 1, comprising moving means for moving an object to be scanned into and out of said container, wherein said moving means comprise at least one runner mounted to said container and drive rollers engaging said at least one runner for rotating said container.

20. A device according to claim 19, wherein said container is an elongated body of revolution which is disposed for rotation about its axis of rotation, wherein a runner is provided on both short sides of said container, and wherein bearing rollers engage said runners.

21. A device according to claim 1, wherein said container is an elongated body of revolution, which is disposed for rotation about its axis of rotation, said container having at least one open short side for receiving an object to be scanned therein, further comprising moving means arranged for moving an object to be scanned into and out of said container via at least one open short side thereof.

22. A device according to claim 1, wherein said container is an elongated body of revolution, which is disposed for rotation about its axis of rotation, said container having at least one open short side for receiving an object to be scanned therein, and wherein a reader is disposed on each short side of said container.

23. A device according to claim 1, wherein said container is an elongated body of revolution, which is disposed for rotation about its axis of rotation, said container having at least one open short said for receiving an object to be scanned therein, wherein a reader is disposed on each short side of said container, and wherein means are provided for moving said container along a path such that each short side of said container is moved past a respective reader.

24. A method for optically scanning three-dimensional objects provided with at least one optically readable code by means of at least one optical reader, comprising the steps of:
placing an object to be scanned in a rotatably disposed container, which container is provided with at least one optically transparent window in a wall thereof,
rotating said container such that said at least one optically readable code of an object received in said container is positioned in front of said at least one window and in that said at least one window is positioned in front of said at least one reader, and
reading said at least one optically readable code by said at least one optical reader.

25. A method according to claim 24, further comprising the steps of termination said rotation of said container and removing said object from said container after an optically readable code of said object has been read.

26. A method according to claim 24, further comprising the steps of terminating said the rotation of said container and removing said object from said container after a predetermined period of time has lapsed after rotation of said container was started.
